(19) United States
(12) Patent Application Publication
(10) Pub. No.: US 2022/0369268 A1
(43) Pub. Date: Nov. 17, 2022

(54) Methods and Apparatuses for Location Area Update

(71) Applicant: Nokia Technologies OY, Espoo (FI)

(72) Inventors: Lei Su, Guangdong (CN); Anna SILLANPAA, Jarvenpaa (FI); Hannu HIETA-LAHTI, Kiviniemi (FI)

(21) Appl. No.: 17/763,007

(22) PCT Filed: Sep. 29, 2019
(86) PCT No.: PCT/CN2019/108877

§ 371 Date: Mar. 23, 2022

(51) Int. Cl. H04W 60/06

(52) U.S. Cl. CPC H04W 60/06

(57) ABSTRACT

Disclosed are apparatuses and methods for location area update. An example method may include transmitting a first request to establish a radio link, the first request including information on a first location area update, transmitting a second request to execute the first location area update via the radio link, and releasing the radio link in response to at least one status of an access stratum feedback to the second request. Related apparatuses and computer readable medium are also disclosed.

### TECHNICAL FIELD

Various example embodiments relate to methods and apparatuses for location area update.

### BACKGROUND

A paging procedure may be used by a network to request an establishment or resumption of a non-access stratum (NAS) signaling connection to a mobile device or user equipment (UE). In order to give the network an idea where to page the UE, the UE may perform be requested by the network to a Tracking Area Update (TAU) or Registration Update. For example, the UE may need to initiate a TAU when entering into another tracking area, and may need to initiate a periodic TAU to keep its registration alive in a tracking area as before. The procedure of a TAU or Registration Update may involve a plurality of message exchanges among the UE, an access network (AN), and a core network (CN), which may cause a high total signaling load, especially when the number of users is dense in an area.

### SUMMARY

In a first aspect, disclosed is a method. The method may include transmitting a first request to establish a radio link, the first request including information on a first location area update, transmitting a second request to execute the first location area update via the radio link, and releasing the radio link in response to at least one status of an access stratum feedback to the second request

In some example embodiments, the information indicates that a one-way update procedure from a mobile device is allowed.

In some example embodiments, the method may further include, in a case where the status of the access stratum feedback indicates receiving a positive acknowledgement, maintaining at least one protocol parameter and setting which has been negotiated between a mobile device and a core network.

In some example embodiments, the method may further include, in a case where the status of the access stratum feedback indicates receiving a negative acknowledgement or missing acknowledgement, initiating at least one second location area update including at least one feedback from a core network to a mobile device.

In some example embodiments, the method may further include initiating the first location area update in responding to an expiration of at least one timer.

In some example embodiments, the method may further include resetting the at least one timer in a case where the status of the access stratum feedback indicates receiving a positive acknowledgement.

In some example embodiments, the method may further include determining an enablement of the first location area update according to a message from a core network.

In some example embodiments, the message may further include a maximum execution number of the first location area update for a mobile device.

In a second aspect, disclosed is a method. The method may include receiving a first request from a mobile device to establish a radio link, the first request including information on a location area update, receiving a second request to execute the location area update via the radio link from the mobile device, transmitting a third request to a core network, the third request being based on the second request and informing the location area update of the mobile device, and releasing the radio link after transmitting an access stratum feedback to the second request via the radio link.

In some example embodiments, the information may indicate that a one-way update procedure from the mobile device is allowed.

In some example embodiments, the method may further including determining an identity associated with the mobile device in a case where the first request is received, the third request being determined based on the second request and the identity.

In a third aspect, disclosed is a method. The method may include receiving information on a location area update regarding a mobile device from an access network, and disabling a location area update feedback to the location area update regarding the mobile device.

In some example embodiments, the information may indicate that a one-way update procedure from the mobile device is allowed.

In some example embodiments, the method may further include, in response to receiving the information on the location area update regarding the mobile device, maintaining at least one protocol parameter and setting which has been negotiated for the mobile device.

In some example embodiments, the method may further include initiating a location area deregistration for the mobile device in responding to an expiration of at least one timer.

In some example embodiments, the method may further include transmitting to the mobile device a message for enabling the first location area update to the mobile device before receiving the information on the first location area update regarding the mobile device.

In some example embodiments, the message may include a maximum execution number of the first location area update for the mobile device.

In some example embodiments, the method may further include, in a case where a current location area of the mobile device is outside of a current location area list of the mobile device, paging the mobile device in at least one location area including the current location area after receiving the information on the first location area update regarding the mobile device.

In a fourth aspect, disclosed is an apparatus. The apparatus may include at least one processor, and at least one memory including computer program code, wherein the at least one memory and the computer program code may be configured to, with the at least one processor, cause the apparatus to perform transmitting a first request to establish a radio link, the first request including information on a first location area update, transmitting a second request to execute the first location area update via the radio link, and releasing the radio link in response to at least one status of an access stratum feedback to the second request.

In some example embodiments, the information may indicate that a one-way update procedure from the apparatus is allowed.

In some example embodiments, the at least one memory and the computer program code may be further configured to, with the at least one processor, cause the apparatus to perform, in a case where the status of the access stratum feedback indicates receiving a positive acknowledgement, maintaining at least one protocol parameter and setting which has been negotiated between the apparatus and a core network.

In some example embodiments, the at least one memory and the computer program code may be further configured to, with the at least one processor, cause the apparatus to perform, in a case where the status of the access stratum feedback indicates receiving a negative acknowledgement or missing acknowledgement, initiating at least one second location area update including at least one feedback from a core network to the apparatus.

In some example embodiments, the at least one memory and the computer program code may be further configured to, with the at least one processor, cause the apparatus to perform initiating the first location area update in responding to an expiration of at least one timer.

In some example embodiments, the at least one memory and the computer program code may be further configured to, with the at least one processor, cause the apparatus to perform resetting the at least one timer in a case where the status of the access stratum feedback indicates receiving a positive acknowledgement.

In some example embodiments, the at least one memory and the computer program code may be further configured to, with the at least one processor, cause the apparatus to perform determining an enablement of the first location area update according to a message from a core network.

In some example embodiments, the message may further include a maximum execution number of the first location area update for the apparatus.

In a fifth aspect, disclosed is an apparatus. The apparatus may include at least one processor, and at least one memory including computer program code, wherein the at least one memory and the computer program code may be configured to, with the at least one processor, cause the apparatus to perform receiving a first request from a mobile device to establish a radio link, the first request including information on a location area update, receiving a second request to execute the location area update via the radio link from the mobile device, transmitting a third request to a core network, the third request being based on the second request and informing the location area update of the mobile device, and releasing the radio link after transmitting an access stratum feedback to the second request via the radio link.

In some example embodiments, the information may indicate that a one-way update procedure from the mobile device is allowed.

In some example embodiments, the at least one memory and the computer program code may be further configured to, with the at least one processor, cause the apparatus to perform determining an identity associated with the mobile device in a case where the first request is received, the third request being determined based on the second request and the identity.

In a sixth aspect, disclosed is an apparatus. The apparatus may include at least one processor, and at least one memory including computer program code, wherein the at least one memory and the computer program code may be configured to, with the at least one processor, cause the apparatus to perform receiving information on a location area update regarding a mobile device from an access network, and disabling a location area update feedback to the location area update regarding the mobile device.

In some example embodiments, the information may indicate that a one-way update procedure from the mobile device is allowed.

In some example embodiments, the at least one memory and the computer program code may be further configured to, with the at least one processor, cause the apparatus to perform, in response to receiving the information on the location area update regarding the mobile device, maintaining at least one protocol parameter and setting which has been negotiated for the mobile device.

In some example embodiments, the at least one memory and the computer program code may be further configured to, with the at least one processor, cause the apparatus to perform initiating a location area deregistration for the mobile device in responding to an expiration of at least one timer.

In some example embodiments, the at least one memory and the computer program code may be further configured to, with the at least one processor, cause the apparatus to perform resetting at least one timer in response to receiving the information on the first location area update regarding the mobile device.

In some example embodiments, the at least one memory and the computer program code may be further configured to, with the at least one processor, cause the apparatus to perform transmitting to the mobile device a message for enabling the first location area update to the mobile device before receiving the information on the first location area update regarding the mobile device.

In some example embodiments, the message may include a maximum execution number of the first location area update for the mobile device.

In some example embodiments, the at least one memory and the computer program code may be further configured to, with the at least one processor, cause the apparatus to perform, in a case where a current location area of the mobile device is outside of a current location area list of the mobile device, paging the mobile device in at least one location area including the current location area after receiving the information on the first location area update regarding the mobile device.

In a seventh aspect, disclosed is an apparatus. The apparatus may include means for transmitting a first request to establish a radio link, the first request including information on a first location area update, means for transmitting a second request to execute the first location area update via the radio link, and means for releasing the radio link in response to at least one status of an access stratum feedback to the second request.

In some example embodiments, the information may indicate that a one-way update procedure from the apparatus is allowed.

In some example embodiments, the apparatus may further include means for, in a case where the status of the access stratum feedback indicates receiving a negative acknowledgement or missing acknowledgement, initiating at least one second location area update including at least one feedback from a core network to the apparatus.

In some example embodiments, the apparatus may further include means for initiating the first location area update in responding to an expiration of at least one timer.

In some example embodiments, the apparatus may further include means for resetting the at least one timer in a case where the status of the access stratum feedback indicates receiving a positive acknowledgement.

In some example embodiments, the apparatus may further include means for determining an enablement of the first location area update according to a message from a core network.

In some example embodiments, the message may further include a maximum execution number of the first location area update for the apparatus.

In an eighth aspect, disclosed is an apparatus. The apparatus may include means for receiving a first request from a mobile device to establish a radio link, the first request including information on a location area update, means for receiving a second request to execute the location area update via the radio link from the mobile device, means for transmitting a third request to a core network, the third request being based on the second request and informing the location area update of the mobile device, and means for releasing the radio link after transmitting an access stratum feedback to the second request via the radio link.

In some example embodiments, the information may indicate that a one-way update procedure from the mobile device is allowed.

In some example embodiments, the apparatus may further include means for determining an identity associated with the mobile device in a case where the first request is received, the third request being determined based on the second request and the identity.

In a ninth aspect, disclosed is an apparatus. The apparatus may include means for receiving information on a location area update regarding a mobile device from an access network, and means for disabling a location area update feedback to the location area update regarding the mobile device.

In some example embodiments, the information may indicate that a one-way update procedure from the mobile device is allowed.

In some example embodiments, the apparatus may further include means for initiating a location area deregistration for the mobile device in responding to an expiration of at least one timer.

In some example embodiments, the apparatus may further include means for resetting at least one timer in response to receiving the information on the first location area update regarding the mobile device.

In some example embodiments, the apparatus may further include means for transmitting to the mobile device a message for enabling the first location area update to the mobile device before receiving the information on the first location area update regarding the mobile device.

In some example embodiments, the message may include a maximum execution number of the first location area update for the mobile device.

In some example embodiments, the apparatus may further include means for, in a case where a current location area of the mobile device is outside of a current location area list of the mobile device, paging the mobile device in at least one location area including the current location area after receiving the information on the first location area update regarding the mobile device.

In a tenth aspect, disclosed is computer readable medium comprising instructions stored thereon for causing an apparatus to perform transmitting a first request to establish a radio link, the first request including information on a first location area update, transmitting a second request to execute the first location area update via the radio link, and releasing the radio link in response to at least one status of an access stratum feedback to the second request.

In some example embodiments, the information may indicate that a one-way update procedure from the apparatus is allowed.

In some example embodiments, the instructions may further cause the apparatus to perform, in a case where the status of the access stratum feedback indicates receiving a positive acknowledgement, maintaining at least one protocol parameter and setting which has been negotiated between the apparatus and a core network.

In some example embodiments, the instructions may further cause the apparatus to perform, in a case where the status of the access stratum feedback indicates receiving a negative acknowledgement or missing acknowledgement, initiating at least one second location area update including at least one feedback from a core network to the apparatus.

In some example embodiments, the instructions may further cause the apparatus to perform initiating the first location area update in responding to an expiration of at least one timer.

In some example embodiments, the instructions may further cause the apparatus to perform resetting the at least one timer in a case where the status of the access stratum feedback indicates receiving a positive acknowledgement.

In some example embodiments, the instructions may further cause the apparatus to perform determining an enablement of the first location area update according to a message from a core network.

In some example embodiments, the message may further include a maximum execution number of the first location area update for the apparatus.

In an eleventh aspect, disclosed is computer readable medium comprising instructions stored thereon for causing an apparatus to perform receiving a first request from a mobile device to establish a radio link, the first request including information on a location area update, receiving a second request to execute the location area update via the radio link from the mobile device, transmitting a third request to a core network, the third request being based on the second request and informing the location area update of the mobile device, and releasing the radio link after transmitting an access stratum feedback to the second request via the radio link.

In some example embodiments, the information may indicate that a one-way update procedure from the mobile device is allowed.

In some example embodiments, the instructions may further cause the apparatus to perform determining an identity associated with the mobile device in a case where the first request is received, the third request being determined based on the second request and the identity.

In a twelfth aspect, disclosed is computer readable medium comprising instructions stored thereon for causing an apparatus to perform receiving information on a location area update regarding a mobile device from an access network, and disabling a location area update feedback to the location area update regarding the mobile device.

In some example embodiments, the information may indicate a one-way procedure from the mobile device.

In some example embodiments, the instructions may further cause the apparatus to perform, in response to receiving the information on the location area update regarding the mobile device, maintaining at least one protocol parameter and setting which has been negotiated for the mobile device.

In some example embodiments, the instructions may further cause the apparatus to perform initiating an location area deregistration for the mobile device in responding to an expiration of at least one timer.

In some example embodiments, the instructions may further cause the apparatus to perform resetting at least one timer in response to receiving the information on the first location area update regarding the mobile device.

In some example embodiments, the instructions may further cause the apparatus to perform transmitting to the mobile device a message for enabling the first location area update to the mobile device before receiving the information on the first location area update regarding the mobile device.

In some example embodiments, the message may include a maximum execution number of the first location area update for the mobile device.

In some example embodiments, the instructions may further cause the apparatus to perform, in a case where a current location area of the mobile device is outside of a current location area list of the mobile device, paging the mobile device in at least one location area including the current location area after receiving the information on the first location area update regarding the mobile device.

### BRIEF DESCRIPTION OF THE DRAWINGS

Some example embodiments will be described, by way of non-limiting examples, with reference to the accompanying drawings.

FIG. 1 illustrates an example procedure of a TAU according to 3GPP Rel-16 specifications.

FIG. 2 illustrates an example procedure of a TAU according to an example embodiment.

FIG. 3 illustrates a comparison between the example procedure of a TAU according to an example embodiment and the example procedure of a TAU according to 3GPP Rel-16 specifications.

FIG. 4 illustrates another example procedure of a TAU according to an example embodiment.

FIG. 5 illustrates an example method on the side of UE according to an example embodiment.

FIG. 6 illustrates another example method on the side of UE according to an example embodiment.

FIG. 7 illustrates another example method on the side of UE according to an example embodiment.

FIG. 8 illustrates an example apparatus on the side of UE according to an example embodiment.

FIG. 9 illustrates another example apparatus on the side of UE according to an example embodiment.

FIG. 10 illustrates an example method on the side of AN according to an example embodiment.

FIG. 11 illustrates another example method on the side of AN according to an example embodiment.

FIG. 12 illustrates an example apparatus on the side of AN according to an example embodiment.

FIG. 13 illustrates another example apparatus on the side of AN according to an example embodiment.

FIG. 14 illustrates an example method on the side of CN according to an example embodiment.

FIG. 15 illustrates another example method on the side of CN according to an example embodiment.

FIG. 16 illustrates another example method on the side of CN according to an example embodiment.

FIG. 17 illustrates an example apparatus on the side of CN according to an example embodiment.

FIG. 18 illustrates another example apparatus on the side of CN according to an example embodiment.

### DETAILED DESCRIPTION

Some example embodiments relate to location area update will now be described by way of non-limiting examples.

In an example embodiment, the “location area” herein may refer to a configuration for position management or mobility management of a UE. For example, a “location area” herein may be a tracking area (TA) in EPS or 5GS, and a “location area list” may be a tracking area list in EPS or 5GS. In another example embodiment, the “location area” herein may also refer to any other current and/or future area configuration suitable for position or mobility management of a UE or other similar functions, for example at a cell level. In another example embodiment, the “location area” herein may also refer to a cell specific configuration. For example, a “location area” herein may correspond to a cell. In another example, for example, when a cell is divided into several parts, a “location area” herein may correspond to one or more part of one cell.

For description convenience, a tracking area will be taken as examples of a location area. However, it is appreciated that the solution of this disclosure may also be applied to any other types of location area and respective procedures of location area update, such as tracking area registration update in 5GS, and the like.

Further, there may be naming convention evolutions among EPS, 5GS, and possible future systems. For description convenience, terms from Long Term Evolution (LTE) system will be mainly used. However, it is appreciated that examples of the tracking area update in the following various example embodiments may include, but not limit to, the TAU in EPS, the Registration Update in 5GS, and any other same or similar procedures in the future; examples of tracking area registration in the following various example embodiments may include, but not limit to, a tracking area attach in EPS, an initial registration in 5GS, and any other same or similar procedures in the future; examples of tracking area deregistration herein may include, but not limit to, a tracking area detach in EPS, a de-registration in 5GS, and any other same or similar procedures in the future; and the like.

Similarly, for description convenience, it is appreciated that, depending on the type of communication system where the solution of this disclosure is applied, for example, a message named with a LTE term “RRC Connection Request” in an example may also refer to the “RRC Setup Request” in 5GS in another example, and may also refer to the same or similar message which is possibly named in another way in the future; a message named with a LTE term “Initial UE Message” in an example may also refer to the “Registration Request” in 5GS in another example; an entity named with a LTE term “Mobility Management Entity” (MME) in an example may be refer to the “Access and Mobility Management Function” (AMF) in 5GS in another example; and the like.

It is appreciated that the solution of this disclosure is not limited to the used terms and the communication system in the following example embodiments.

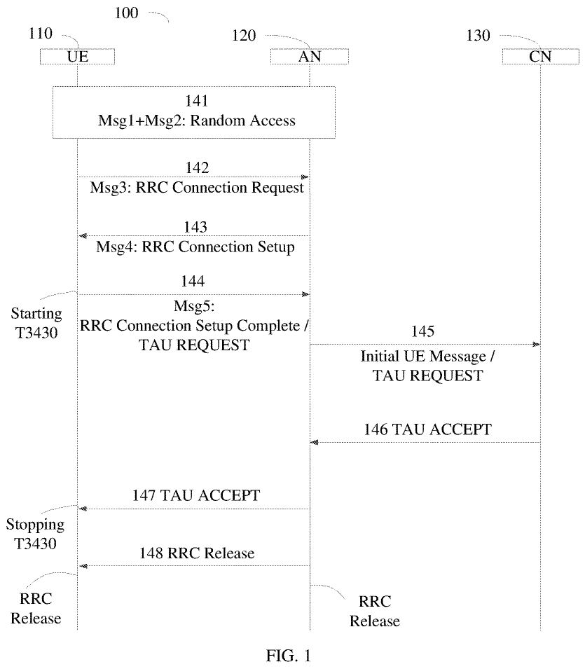

FIG. 1 illustrates an example procedure 100 of a TAU according to 3GPP Rel-16 specifications, which involves a plurality of signaling exchanges among the UE 110, the AN 120 (e.g. a base station in the AN), and the CN 130 (e.g. an MME or AMF in the CN).

As shown in the block 141 of FIG. 1, during the example procedure 100, the UE 110 may initiate a Random Access (RA) to the AN 120 by transmitting a message Msg1 carrying a RA preamble to the AN 120 via a common control channel (CCCH) or Signaling Radio Bearer (SRB0), and the AN 120 may feedback a message Msg2 carrying a RA Response (RAR) to the UE 110 via the CCCH or SRB0.

Then, the UE 110 may transmit a message 142, i.e. Msg3 carrying a Radio Resource Control (RRC) Connection Request, to the AN 120 via the CCCH or SRB0, so as to request to establish a radio link for the UE 110, e.g. to establish a dedicated control channel (DDCH) or Signaling Radio Bearer 1 (SRB1) for the UE 110. If the connection is allowed for the UE 110, the AN 120 may transmit a message 143, i.e. Msg4 carrying RRC Connection Setup, to the UE 110. For example, the Msg4 may include information on the radio link, so that the UE 110 may use the radio link after receiving the Msg4.

As shown in FIG. 1, the UE 110 may transmit a message 144, i.e. Msg5 including an access stratum (AS) message of RRC Connection Setup Complete and an NAS message of TAU Request, to the AN 120 via the established radio link or SRB1. As shown in FIG. 1, the UE 110 may also start a timer T3430 for waiting a TAU ACCEPT message 147 from the CN 130.

Then, the AN 120 may transmit an Initial UE Message 145 including the TAU Request message to the CN 130, and may forward the TAU Accept message 146 from the CN 130 to the UE 110. After forwarding the TAU Accept message 146 to the UE 110, the AN 120 may transmit a message 148 carrying an instruction of RRC Release 148 to the UE 110, and then release the RRC connection.

On the side of UE 110, the UE 110 may stop the timer T3430 after receiving the TAU Accept message 147 from AN 120, and may release the established radio link or SRB1 after receiving the message 148 carrying the instruction of RRC Release from the AN 120.

As shown in FIG. 1, the example procedure 100 includes at least one feedback from the CN 130 to the UE 110, and at least 9 message exchanges among the UE 110, the AN 120, and the CN 130 are involved. In addition, for 5GS, additional message transmissions between a Centralized Unit (CU) and a Distributed Unit (DU) may be involved, and therefore at least 10 message exchanges are involved.

For example, there is a case where a subscriber may perform about 2.06 TAUs due to mobility in inactive/idle sate and about 86 paging procedures in one busy hour, so that total signaling load becomes very high. For example, the message load per cell during a busy hour may be up to about 115,360 message exchanges via Uu interface, and may also include about 49,400 message exchanges via New Radio Application Protocol (NGAP) and F1 interfaces in the case of 5GS.

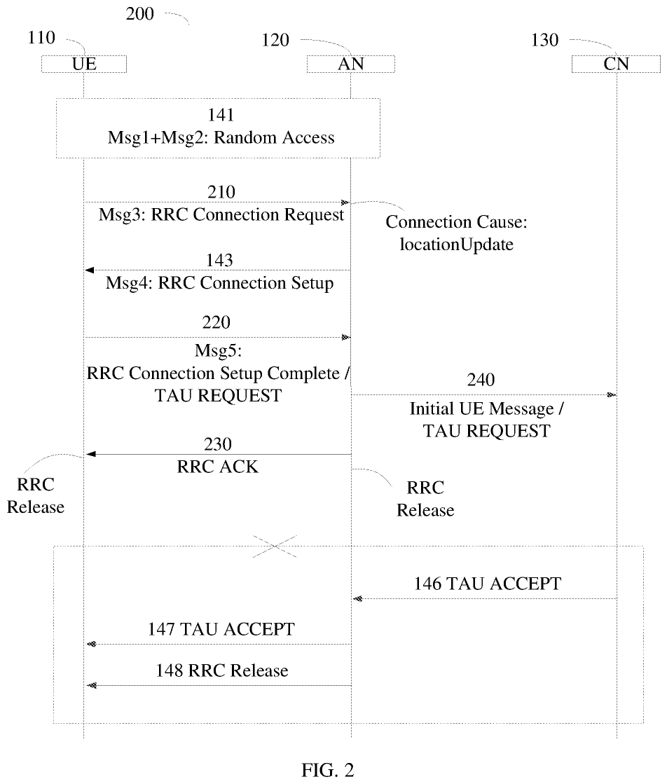

To reduce the signaling load, an example procedure 200 of TAU according to an example embodiment is illustrated in FIG. 2.

As shown in FIG. 2, in the example procedure 200, the UE 110 may transmit to the AN 120 a request 210, i.e. Msg3 carrying RRC Connection Request and information on the example procedure 200. In the example of FIG. 2, the information on the example procedure 200 included in the request 210 may be a cause for establishing the connection with a new call type “locationUpdate”, so that the AN 120 may determine its operations according to the request 210.

Then, via the established radio link or SRB1 which may be informed through the message 143 as in the example procedure 100, the UE 110 may transmit a request 220 to the AN 120. The request 220 is Msg 5 including RRC Connection Setup Complete and a TAU Request. In various example embodiments, the TAU Request included in the request 220 may be either a reused TAU Request Protocol Data Unit (PDU) or a new PDU designed for the example procedure 200, more details of which will be described later.

In addition, on the side of the UE 110, as shown in FIG. 2, the established radio link or SRB1 is released in response to receiving an AS feedback 230 carrying RRC ACK from the AN 120, rather than in response to receiving the message 148 carrying the instruction of RRC Release from the AN 120 which is after the TAU ACCEPT message 147 forwarded by the AN 120 as in the example procedure 100.

For example, when the UE 110 receives the AS feedback 230 which is positive feedback, the UE 110 may continue to use one or more parameters and/or settings, such as TA list, Discontinuous Reception (DRX) or eDRX parameters, Mobile Initiated Connection Only (MICO) mode parameters, Active Timer, subscriber information, network configuration, a temporary identifier for the UE 110, and the like, which have been negotiated between the UE 110 and the CN 130 in a latest TA Register procedure or the example procedure 100. Otherwise, for example, the UE 110 may switch to perform the example procedure 100.

As shown in FIG. 2, on the side of AN 120, after receiving the request 220 from the UE 110 via the established radio link or SRB1, an Initial UE Message 240 including the TAU Request message may be generated and transmitted to the CN 130. In various example embodiments, the TAU Request message in the Initial UE Message 240 may be generated based on the TAU Request in the request 220, or may be the same with the TAU Request in the request 220, more details of which will be described later.

In addition, as shown in FIG. 2, on the side of the AN 120, the established radio link or SRB1 is released after transmitting the AS message 230, rather than after forwarding the TAU Accept message 146 from the CN 130 to the UE 110 and transmitting the message 148 carrying the instruction of RRC Release to the UE 110 as in the example procedure 100.

On the side of the CN 130, feedback to the TAU Request message in the Initial UE Message 240 may be disabled. As shown in FIG. 2, no TAU Accept message is transmitted to the UE 110. More details on the side of CN 130 will be described later.

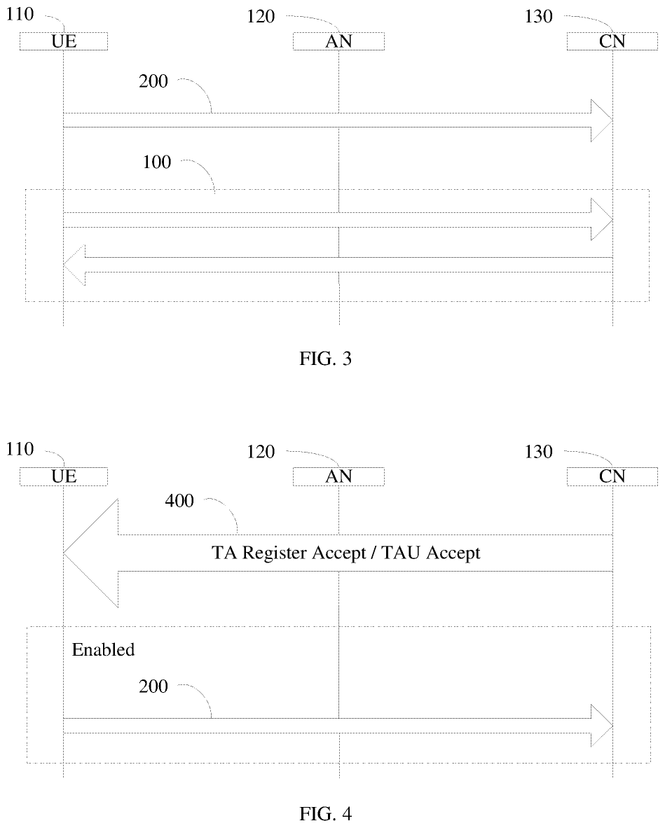

As shown in FIG. 2, in the example procedure 200, one or more NAS feedbacks from the CN 130 to the UE 110 are omitted. For example, messages 146-148 to the UE 110 in the example procedure 100 are omitted in the example procedure 200. Thus, also as shown in FIG. 3, different form the example procedure 100 which includes both NAS signaling from the UE 110 to the CN 130 and NAS signaling from the CN 130 to the UE 110, the example procedure 200 implements a “one-way” update procedure from the UE 110 to the CN 130, without NAS feedbacks from the CN 130 to the UE 110.

Through the example procedure 200, about 28.6% signaling reduction via the Uu interface and about 66.7% signaling reduction via the NGAP and F1 interfaces may be observed. Besides, in the example procedure 200, the UE 110 may move back to an inactive mode quickly without waiting for NAS feedbacks from the CN 130, which may help power saving of the UE 110.

Further, as shown in FIG. 4, in some example embodiments, the example procedure 200 may be controlled by the CN 130. For example, the UE 110 may receive control information on the example procedure 200 from the CN 130, e.g. one or more of a tag indicating whether the example procedure 200 is enabled, a maximum execution number of the example procedure 200 for the UE 110, and the like. As shown in FIG. 4, such control information may be conveyed by message 400 from the CN 130, such as a TA Register Accept during a TA registration before the example procedure 200, or a TAU Accept message during an example procedure 100 before the example procedure 200.

Subsequently, for example, the example procedure 200 will not be performed unless it is enabled by the CN 130, and the UE 110 may switch to perform the example procedure 100 if an execution number of the example procedure 200 has reached to the indicated maximum execution number. To this end, both the UE 110 and the CN 130 may be enabled to have an opportunity to update some protocol parameters and/or settings such as DRX or eDRX parameters, MICO mode parameters, Active Timer, subscriber information, network configuration, a temporary identifier for the UE 110, and the like, for example for security reasons.

FIGS. 2-4 illustrate several aspects of the disclosure by way of non-limiting examples, and one or more message exchanges in the actual cases are omitted during the description. More details and one or more additional or alternative aspects of the example procedure 200 on the sides of the UE 110, the AN 120, and the CN 130 will now be described, respectively, by way of non-limiting examples.

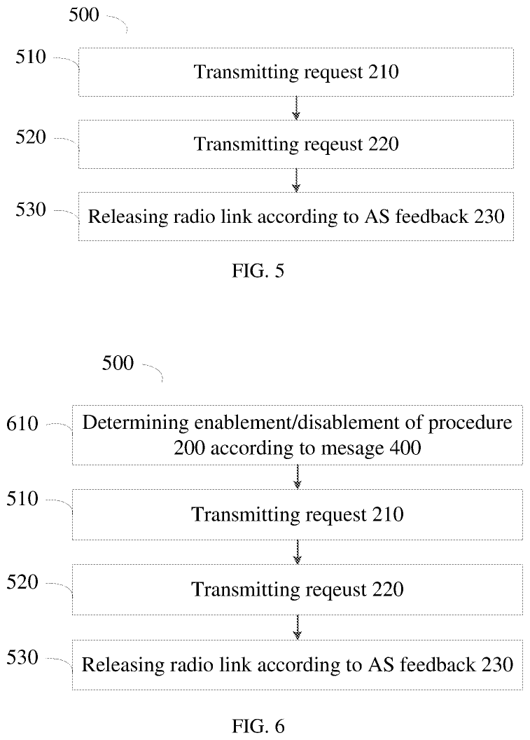

FIG. 5 illustrates an example method 500 according to an example embodiment, which, for example, may be performed on the side of the UE 110 during the example procedure 200 in FIGS. 2-4.

As shown in FIG. 5, the example method 500 may include a step 510 of transmitting a request 210 to establish a radio link (e.g. SRB1), a step 520 of transmitting a request 220 to execute the example procedure 200 via the established radio link, and a step 530 of releasing the radio link in response to one or more statuses of an AS feedback 230 to the request 220.

In various example embodiments, the request 210 transmitted at the step 510 may include information on the example procedure 200. For example, the information in the request 210 may indicate that a “one-way” update procedure initiated by the UE 110 is allowed, or that no feedback from the CN 130 is required for the current procedure, or the like.

In the example of FIG. 2, the information included in the request 210 is a new call type “locationUpdate” corresponding to a new RRC establishment cause for a TAU procedure. In another example, other description of the RRC establishment cause and other suitable call type may be used for the request 210 in the example procedure 200.

Such information on the example procedure 200 included in the request 210 may be used on the side of the AN 120, so that the AN 120 may determine the subsequent operations according to the information.

As shown in FIG. 5, after transmitting the request 210 at the step 510, the example method 500 may proceed to the step 520 to transmit the request 220.

In an example embodiment, the TAU Request in the request 220 transmitted at the step 520 may be the same as, or say reuse, the TAU Request in the message 144 in the example procedure 100. In this case, a further processing (e.g. a combination with other information) on the side of AN 120 may be needed, so that the CN 130 may determine whether the example procedure 200 or the example procedure 100 is requested according to for example the information added on the side of AN 120.

In another example embodiment, the TAU Request in the request 220 transmitted at the step 520 may be a modified PDU based on the TAU Request in the message 144 in the example procedure 100, for example with one or more additional parameters added or changed. For example, a new value for the EPS update type Information Element (IE) for the example procedure 200 may be added, such as “one-way updating”, so as to be distinguished from the EPS update IEs “TA updating” and “periodic updating” in the TAU Request PDU in example procedure 100, so that the CN 130 may determine whether the example procedure 200 or the example procedure 100 is requested according to for example the EPS update in the received TAU Request.

In another example, the TAU Request transmitted at the step 520 may be a new PDU for the example procedure 200, which is different or separate from the TAU Request in the example procedure 100, so that the CN 130 may determine whether the example procedure 200 or the example procedure 100 is requested according to for example the PDU Identity of the received TAU Request.

Then, as shown in FIG. 5, the example method 500 may proceed to the step 530 to release the radio link in response to one or more statuses of the AS feedback 230 to the request 220.

An example of the AS feedback 230 to the request 220 may include an explicit Acknowledgement (ACK) or Negative Acknowledgement (NACK) or the like in Radio Link Control (RLC) and with (Hybrid) Automatic Repeat Request ((H)ARQ) in the AS such as Layer 1 or 2.

In various examples, the status of the AS feedback 230 to the request 220 may include, but be not limited to, receiving a positive acknowledgement such as a RLC ACK from the AN 120, receiving an NACK such as a RLC NACK from the AN 120, missing a RLC ACK or NACK from the AN 120, detecting any other RLC failure, and the like. For example, receiving a positive AS feedback 230 may mean a success of the example procedure 200, otherwise a failure.

In an example embodiment, in order to detect the status of the AS feedback 230, for example, a timer may be configured on the side of the UE 110. The timer may be started in response to transmitting the request 220 at the step 520. Then, at the step 530, for example, if the timer expires and no AS feedback 230 is received, a failure status of the AS feedback 230 may be determined. If an AS feedback 230 is received before the timer expires, the status of the AS feedback 230 may be determined based on the acknowledgement type of the AS feedback 230.

Once determining one or more statuses of the AS feedback 230 to the request 220, the established radio link or SRB1 may be released at the step 530, without waiting for an instruction of RRC Release from the AN 120 and any NAS feedback from the CN 130 as in the example procedure 100. Thus, a “one-way” update procedure is implemented, through which the total signaling load may be reduced and the UE 110 may move back to an inactive mode quickly without waiting for NAS feedbacks from the CN 130.

Further, in an example embodiment, when the status of the AS feedback 230 is a success status, the UE 110 may continue to use, or say maintain, one or more protocol parameters and/or settings which have been negotiated between the UE 110 and the CN 130, for example in the latest successful example procedure 100 or the latest successful TA registration. Various examples of such protocol parameters and/or settings may include, but be not limited to, TA list, authentication, mobility management context, bearer, IP address, identity, DRX or eDRX parameters, MICO mode parameters, Active Timer, and the like.

In addition, when the status of the AS feedback 230 is a success status, one or more timers on the side of UE 110, e.g. the periodic update timer T3412, may be re-start with respective initial values.

When the status of the AS feedback 230 is a failure status, the UE 110 may initiate one or more example procedures 100.

In some example embodiments, the example procedure 200 may be a periodic TAU procedure which is initiated in response to an expiration of one or more timers on the side of UE 110. For example, if the UE is RRC IDLE state, the example procedure 200 may be initiated upon the periodic update timer T3412 expires. As described above, the periodic update timer T3412 may be reset to when one example procedure 200 is determined success according to the status of the AS feedback 230, so that a next example procedure 200 may be initiated again once the periodic update timer T3412 expires again.

Further, as described above with reference to FIG. 4, in some example embodiments, the example procedure 200 may be enabled or disabled by the CN 130. Consequently, as shown in FIG. 6, the example method 500 may further include a step 610 of determining an enablement or disablement of the example procedure 200 according to the message 400 from the CN 130. As described above with reference to FIG. 4, the message 400 may be a TA Register Accept message during a TA registration before the example procedure 200, or a TAU Accept message during an example procedure 100 before the example procedure 200.

As described above with reference to FIG. 4, in some example embodiments, the message 400 from the CN 130 may also include a maximum execution number of the example procedure 200 for the UE 110, or a default maximum execution number may be used. For example, a counter for an execution umber of the example procedure 200 may be configured on the side of the UE 110. When the execution number of the example procedure 200 according to the counter becomes larger than the maximum execution number, the example procedure 100 may be initiated for one or more times by the UE 110.

In some example embodiments, the maximum execution number may be also used to indicate whether the example procedure 200 is enabled. For example, if the maximum execution number with a zero value or any other predetermined value may indicate a disablement of the example procedure 200. In another example embodiment, separate IEs for an enablement tag and the maximum execution number may be configured.

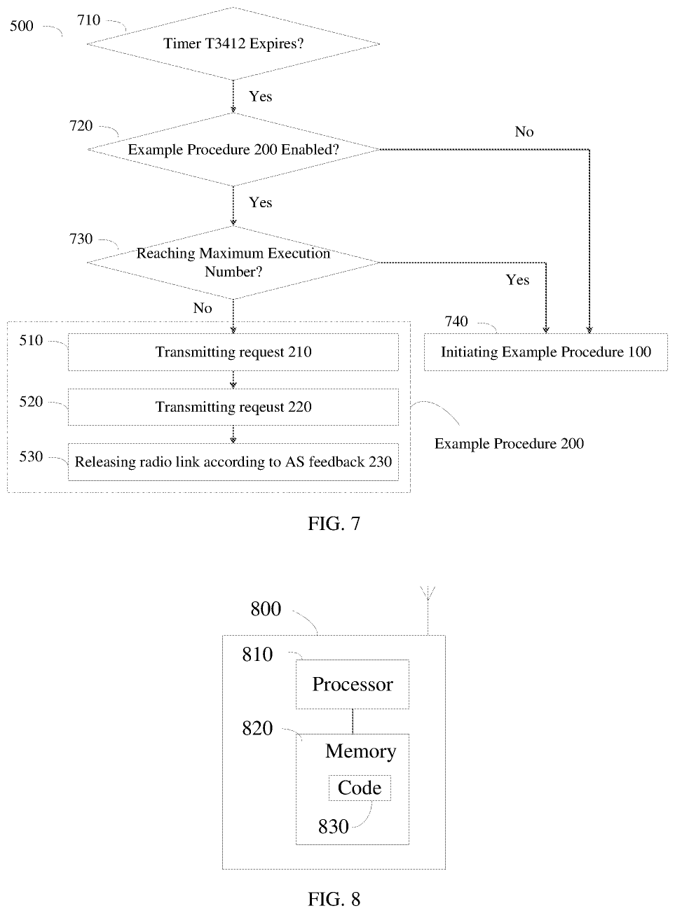

As shown in FIG. 7, the example procedure 200 may be initiated according to a combination of the above conditions, through further steps 710, 720, and 730 in the example method 500.

For example, if an expiration of the periodic update timer T3412 is detected at a step 710, the example 700 proceeds to a step 720 to check whether the example procedure 200 is enabled. If the check result at the step 720 indicates “No”, the example procedure 100 will be initiated at a step 740, and otherwise a further check on whether the execution numbers have reached the maximum execution number will be performed at a step 730. If the check result at the step 730 indicates “No”, the example procedure 200 including the steps 510, 520, and 530 will be initiated, and otherwise the example procedure 100 will be initiated at the step 740.

It is appreciated that the execution conditions for the example procedure 200 are not limited to the above examples, and the sequence of respective checking steps are not limited to the example in FIG. 7.

FIG. 8 illustrates an example apparatus 800 according to an example embodiment, which, for example, may be at least a part of the UE 110.

As shown in FIG. 8, the example apparatus 800 may include at least one processor 810 and at least one memory 820 that may include computer program code 830. The at least one memory 820 and the computer program code 830 may be configured to, with the at least one processor 810, cause the apparatus 800 at least to perform at least the example method 500 described above.

In various example embodiments, the at least one processor 810 in the example apparatus 800 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 810 may also include at least one other circuitry or element not shown in FIG. 8.

In various example embodiments, the at least one memory 820 in the example apparatus 800 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 820 may include, but are not limited to, an electric, a magnetic, an optical, an electromagnetic, an infrared, or a semiconductor system, apparatus, or device or any combination of the above.

Further, in various example embodiments, the example apparatus 800 may also include at least one other circuitry, element, and interface, for example at least one I/O interface, at least one antenna element, and the like.

In various example embodiments, the circuitries, parts, elements, and interfaces in the example apparatus 800, including the at least one processor 810 and the at least one memory 820, may be coupled together via any suitable connections including, but not limited to, buses, crossbars, wiring and/or wireless lines, in any suitable ways, for example electrically, magnetically, optically, electromagnetically, and the like.

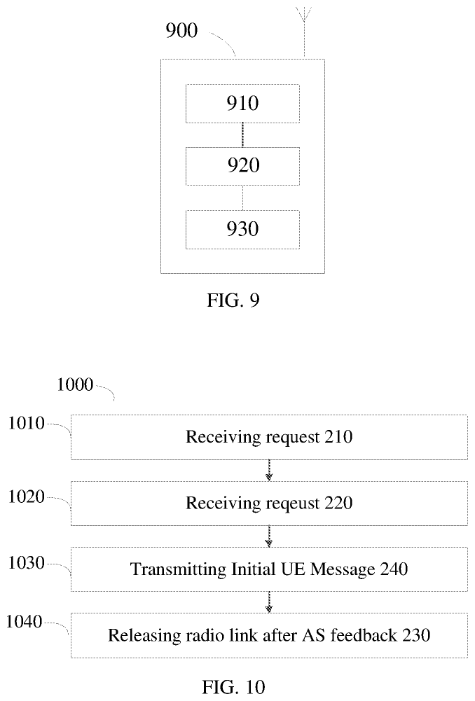

The structure of the apparatus on the side of the UE 110 is not limited to the above example apparatus 800. FIG. 9 illustrates another example apparatus 900 according to an example embodiment, which, for example, may be at least of part of the UE 110.

As shown in FIG. 9, the example apparatus 900 may include means 910 for performing the step 510 of the example method 500, means 920 for performing the step 520 of the example method 500, and means 930 for performing the step 530 of the example method 500.

In one or more another example embodiments, the example apparatus 900 may further include one or more another means for performing other additional or alternative steps in the example method 500. For example, the example apparatus 900 may further include one or more another means for initiating the example procedure 100 according to the status of the AS feedback 230, checking the enablement and/or the execution number of the example procedure 200, and the like. Further, for example, at least one I/O interface, at least one antenna element, and the like may also included in the example apparatus 900.

Several example embodiments on the side of the UE 110 have been described above by way of non-limiting examples. More details on the side of the AN 120 will now be described by way of non-limiting examples.

FIG. 10 illustrates an example method 1000 according to an example embodiment, which, for example, may be performed on the side of the AN 120 during the example procedure 200 in FIGS. 2-4.

As shown in FIG. 10, correspond to the step 510 of the example method 500, the example method 1000 may include a step 1010 of receiving the request 210 from the UE 110 to establish the radio link. Correspond to the step 520 of the example method 500, the example method 1000 may further include a step 1020 of receiving, from the UE 110, the request 220 to execute the the example procedure 200 via the established radio link. Correspond to the step 530 of the example method 500, the example method 1000 may further include a step 1040 of releasing the radio link after transmitting the AS feedback 230 to the request 220 via the radio link. Further, the example method 1000 may further include a step of 1030 of transmitting the Initial UE Message 240 including the TAU Request message to the CN 130.

Although the step 1030 is shown before the step 1040 in FIG. 10, in another example, the two steps may be executed in parallel or in a different order as shown in FIG. 10.

As described above for the embodiments on the side of UE 110, the request 210 received at the step 1010 may include information on the example procedure 200. For example, the AN 120 may parse the received request 210, and determine that the TAU procedure to be executed is the example procedure 200 when the information carried by the request 210 indicates a call type (e.g. “locationUpdate”) corresponding to the example procedure 200. If a call type corresponding to the example procedure 200 is determined, the AN 120 may release the established radio link at the step 1040 without waiting for and forwarding feedbacks from the CN 130 to the UE 110, and without transmitting an explicit instruction (e.g. message 148 in FIG. 2) to the UE 110.

As described above for the embodiments on the side of UE 110, the TAU Request in the request 220 received at the step 1020 may be the same as, or say reuse, the TAU Request in the message 144 in the example procedure 100. In this case, in order to enable the CN 130 to recognize an execution of the example procedure 200, as shown in FIG. 11, the example method 100 may further include a step 1110 of determining an identity associated with the UE 110. In various examples, the identity associated with the UE 110 may be any suitable identity, for example, a Random Access Channel (RACH) cell Physical Cell Identifier (PCI), and the Initial UE Message 240 may be determined by the AN 120 based on the request 220 and the identity determined at the step 1110. For example, the Initial UE Message 240 may be generated by combining the request 220 or the TAU request in the request 220 with the identity determined at the step 1110, so that the CN 130 may determine the example procedure 200 if finding the additional identity in the received Initial UE Message 240.

In another example embodiment, as described above, the TAU Request in the request 220 received at the step 1020 may be a modified PDU based on the TAU Request in the message 144 in the example procedure 100, for example with one or more additional parameters added or changed. For example, a new value for the EPS update type IE for the example procedure 200, such as “one-way updating”. In another example embodiment, as described above, the TAU Request received at the step 520 may also be a new PDU for the example procedure 200, which is different or separate from the TAU Request in the example procedure 100.

In both of the above two cases, the information elements in the request 220 or the TAU Request in the request 220 are enough for the CN 130 to determine if the example procedure 200 is requested. Then, back to the FIG. 10, for example, the AN 120 may perform no additional operations such as the step 1110 in FIG. 11, and may directly forward the received request 220 as the Initial UE Message 240 to the CN 130, or the AN 120 may perform operations on the received request 220 as those in the example procedure 100 when receiving the request 220 and then forward the generated Initial UE Message 240 to the CN 130.

On the other hand, if the information in the request 210 received at the step 1010 does not indicate the call type (e.g. “locationUpdate”) corresponding to the example procedure 200, for example, the AN 120 may switch to perform operations similar to those in the example procedure 100.

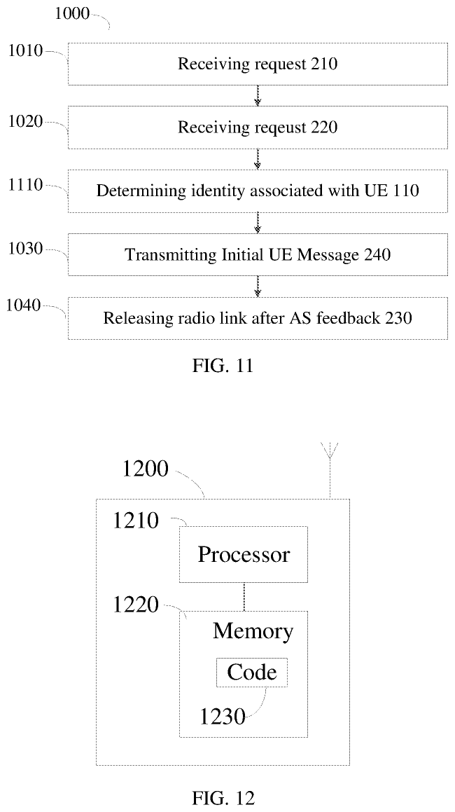

FIG. 12 illustrates an example apparatus 1200 according to an example embodiment, which, for example, may be at least a part of the AN 120, e.g. at least part of a base station of the AN 120.

As shown in FIG. 12, the example apparatus 1200 may include at least one processor 1210 and at least one memory 1220 that may include computer program code 1230. The at least one memory 1220 and the computer program code 1230 may be configured to, with the at least one processor 1210, cause the apparatus 1200 at least to perform at least the example method 1000 described above.

In various example embodiments, the at least one processor 1210 in the example apparatus 1200 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 1210 may also include at least one other circuitry or element not shown in FIG. 12

In various example embodiments, the at least one memory 1220 in the example apparatus 1200 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 1220 may include, but are not limited to, an electric, a magnetic, an optical, an electromagnetic, an infrared, or a semiconductor system, apparatus, or device or any combination of the above.

Further, in various example embodiments, the example apparatus 1200 may also include at least one other circuitry, element, and interface, for example at least one I/O interface, at least one antenna element, and the like.

In various example embodiments, the circuitries, parts, elements, and interfaces in the example apparatus 1200, including the at least one processor 1210 and the at least one memory 1220, may be coupled together via any suitable connections including, but not limited to, buses, crossbars, wiring and/or wireless lines, in any suitable ways, for example electrically, magnetically, optically, electromagnetically, and the like.

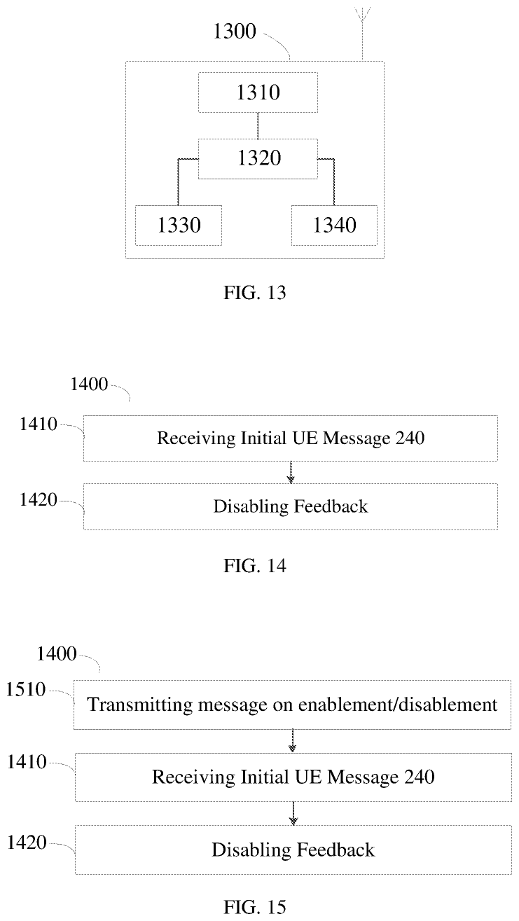

FIG. 13 illustrates another example apparatus 1300 according to an example embodiment, which, for example, may be at least a part of the AN 120, e.g. at least part of a base station of the AN 120.

As shown in FIG. 13, the example apparatus 1300 may include means 1310 for performing the step 1010 of the example method 1000, means 1320 for performing the step 1020 of the example method 1000, means 1330 for performing the step 1030 of the example method 1000, and means 1340 for performing the step 1040 of the example method 1000.

In one or more another example embodiments, the example apparatus 1300 may further include one or more another means for performing other additional or alternative steps in the example method 1000. For example, the example apparatus 1300 may further include one or more another means for performing the step 1110 in FIG. 11 and/or generating the Initial UE Message 240. Further, for example, at least one I/O interface, at least one antenna element, and the like may also included in the example apparatus 1300.

Several example embodiments on the sides of the UE 110 and the AN 120 have been described above by way of non-limiting examples. More details on the side of the CN 130 will now be described by way of non-limiting examples.

FIG. 14 illustrates an example method 1400 according to an example embodiment, which, for example, may be performed on the side of the CN 130 during the example procedure 200 in FIGS. 2-4.

As shown in FIG. 14, corresponding to the step 1030 of the example method 1000, the example method 1400 may include a step 1410 of receiving the Initial UE Message 240 from the AN 120, which may carry information on the example procedure 200 regarding the UE 110.

If the TAU request in the Initial UE Message 240 is a reused PDU and an additional identity associated with the UE 110 is detected, or if the TAU request in the Initial UE Message 240 is a modified PDU with for example a new value for the EPS update type IE for the example procedure 200 (e.g. “one-way updating”) included, the example method 1400 may proceed to a step 1420 to disabling TAU feedback (e.g. TAU Accept).

If the TAU request in the Initial UE Message 240 is a PDU dedicated for the example procedure 200, the CN 130 may perform operations corresponding to the example procedure 200, and these operations do not include transmitting TAU feedback (e.g. TAU Accept) to the UE 110.

When determining the example procedure 200 according to the received Initial UE Message 240, the CN 130 may continue to use, or say maintain, one or more protocol parameters and/or settings which have been negotiated between the UE 110 and the CN 130, for example in the latest successful example procedure 100 or the latest successful TA registration. Various examples of such protocol parameters and/or settings may include, but be not limited to, TA list, authentication, mobility management context, bearer, IP address, identity, DRX or eDRX parameters, MICO mode parameters, Active Timer, and the like.

Further, as described before and also as shown in FIG. 15 with reference to FIG. 4, the example method 1400 may further include a step 1510 of transmitting to the UE 110 a message for enabling or disabling the example procedure 200 for the UE 110. For example, the message for informing the enablement or disablement of the example procedure 200 may be based on TA Register Accept PDU or TAU Accept PDU, for example with an IE indicating “enabled/disabled” added. In addition or alternatively, an IE indicating “maximum execution number of the example procedure 200” may also be added in TA Register Accept PDU or TAU Accept PDU.

For example, the maximum execution number of the example procedure 200 may be configured with a default value, e.g. 3, 4, 5, and other suitable values. Also, the maximum execution number of the example procedure 200 may be configurable. For example, the maximum execution number of the example procedure 200 may be determined on the side of the CN 130, according to for example the type and/or speed of the UE 110, the cell coverage, TAU configuration, busy hour v.s. non-busy hour, and any other suitable information, by performing for example a Machine Learning method and the like. For example, the maximum execution number of the example procedure 200 for a non-mobile type UE may be larger than that for a fast moving UE.

Further, for example, when receiving the Initial UE Message 240 indicating the example procedure 200, the CN 130 may reset one or more timers so as to mark the UE 110 as “reachable” explicitly or implicitly. When one or more timers expire, the CN 130 may mark the UE 110 as “unreachable” explicitly or implicitly, and may initiate a TA Deregistration for the UE 110.

For example, the mobile reachable timer on the side of CN 130 may be reset when receiving the Initial UE Message 240 indicating the example procedure 200. For example, the mobile reachable timer may be configured according to the maximum execution number of the example procedure 200. When the mobile reachable timer expires, an implicit detach timer may be started, during which period the UE 110 may correspond to a “possibly unreachable” state. Then, after the implicit detach timer expires, the UE 110 may be determined to be “unreachable”, and a TA Deregistration for the UE 110 may be initiated.

For example, the maximum timing value of the mobile reachable timer may be configured as one or more times of the maximum execution number of the example procedure 200. For example, the mobile reachable timer is configured as the example procedure 100, and the implicit detach timer may be configured to be much longer than that in the example procedure 100, for example, to be at least (the mobile reachable timer)*(the maximum execution number of the example procedure 200−1). In another example, a timer corresponding to ((the mobile reachable timer)*(the maximum execution number of the example procedure 200−1)+the implicit detach timer) may be configured.

Thus, for example in a case where the Initial UE Message 240 is missed between the AN 120 and the CN 130, which cannot be detected on the side of the UE 110 when executing the example procedure 200, the CN 130 may avoid a premature implicit detach of the UE 110.

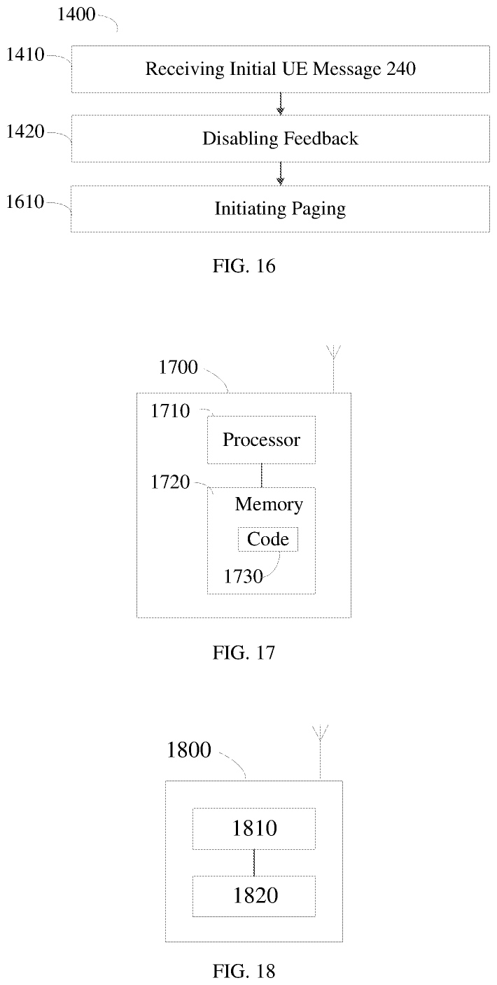

In the above examples, the example procedure 200 is used as a periodic TAU update. In another example, the example procedure 200 may also be applied to the case where the UE 110 moves into a new TA. In this case, as shown in FIG. 16, the example method 1400 may also include a step 1610 of paging the UE 110 in at least one TA including a current TA of the UE 110 if the current TA of the UE 110 is outside of current TA list of the UE 110.

Although this step 1610 is shown after the step 1420 in FIG. 16, the step 1610 may be executed after the step 1410, for example before the step 1420 or in parallel with the step 1420.

For example, when the UE 110 determines that the TA where it currently locates is not in its local TA list according to the system broadcast message SIB1, the UE 110 may initiate the example procedure 200, for example without considering the timer T3412. Then, the CN 130 may page the UE 110 in one or more TAs including the TA where the UE 110 currently locates, for example may page the UE 110 in the TA where the UE 110 currently locates. Then, in response to the paging from the CN 130, the UE 110 may initiate a TA register or a TAU like the example procedure 100 to update the information of TA list. Such a procedure may also be helpful for signaling load reduction.

FIG. 17 illustrates an example apparatus 1700 according to an example embodiment, which, for example, may be at least a part of the CN 130, e.g. at least a part of MME or AMF of the CN 130.

As shown in FIG. 17, the example apparatus 1700 may include at least one processor 1710 and at least one memory 1720 that may include computer program code 1730. The at least one memory 1720 and the computer program code 1730 may be configured to, with the at least one processor 1710, cause the apparatus 1700 at least to perform at least the example method 1400 described above.

In various example embodiments, the at least one processor 1710 in the example apparatus 1700 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 1710 may also include at least one other circuitry or element not shown in FIG. 17.

In various example embodiments, the at least one memory 1720 in the example apparatus 1700 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 1720 may include, but are not limited to, an electric, a magnetic, an optical, an electromagnetic, an infrared, or a semiconductor system, apparatus, or device or any combination of the above.

Further, in various example embodiments, the example apparatus 1700 may also include at least one other circuitry, element, and interface, for example at least one I/O interface, at least one antenna element, and the like.

In various example embodiments, the circuitries, parts, elements, and interfaces in the example apparatus 1700, including the at least one processor 1710 and the at least one memory 1720, may be coupled together via any suitable connections including, but not limited to, buses, crossbars, wiring and/or wireless lines, in any suitable ways, for example electrically, magnetically, optically, electromagnetically, and the like.

The structure of the apparatus on the side of the CN 130 is not limited to the above example apparatus 1700. FIG. 18 illustrates another example apparatus 1800 according to an example embodiment, which, for example, may be at least a part of the CN 130, e.g. at least a part of MME or AMF of the CN 130.

As shown in FIG. 18, the example apparatus 1800 may include means 1810 for performing the step 1410 of the example method 1400, and means 1820 for performing the step 1420 of the example method 1400.

In one or more another example embodiments, the example apparatus 1400 may further include one or more another means for performing other additional or alternative steps in the example method 1400. For example, the example apparatus 1400 may further include one or more another means for performing the steps 1510 and/or 1610. Further, for example, at least one I/O interface, at least one antenna element, and the like may also included in the example apparatus 1800.

Another example embodiment may relate to computer program codes or instructions which may cause an apparatus to perform at least respective methods described above.

Another example embodiment may be related to a computer readable medium having such computer program codes or instructions stored thereon. In various example embodiments, such a computer readable medium may include at least one storage medium in various forms such as a volatile memory and/or a non-volatile memory. The volatile memory may include, but not limited to, for example, a random-access memory (RAM), a cache, and so on. The non-volatile memory may include, but not limited to, a read only memory (ROM), a hard disk, a flash memory, and so on.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While some example embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. The order of these blocks may also be changed. Any suitable combination of the elements and acts of the various embodiments described above can be combined to provide further embodiments. The accompanying claims and their equivalents are intended to cover such forms or modifications as would fall within the scope and spirit of the disclosure.

1. A method comprising:
transmitting a first request to establish a radio link, the first request including information on a first location area update;
transmitting a second request to execute the first location area update via the radio link; and
releasing the radio link in response to at least one status of an access stratum feedback to the second request.

2. The method of claim 1 wherein the information indicates that a one-way update procedure from a mobile device is allowed.

3. The method of claim 1 further comprising:
in response to the status of the access stratum feedback indicates receiving a negative acknowledgement or missing acknowledgement, initiating at least one second location area update including at least one feedback from a core network to a mobile device.

4. The method of claim 1 further comprising:
initiating the first location area update in responding to an expiration of at least one timer; and
resetting the at least one timer in a case where the status of the access stratum feedback indicates receiving a positive acknowledgement.

5. The method of claim 1 further comprising:
determining an enablement of the first location area update according to a message from a core network.

6. The method of claim 5 wherein the message further includes a maximum execution number of the first location area update for a mobile device.

7. A method comprising:
receiving a first request from a mobile device to establish a radio link, the first request including information on a location area update;
receiving a second request to execute the location area update via the radio link from the mobile device;
transmitting a third request to a core network, the third request being based on the second request and informing the location area update of the mobile device; and
releasing the radio link after transmitting an access stratum feedback to the second request via the radio link.

8. The method of claim 7 wherein the information indicates that a one-way update procedure from the mobile device is allowed.

9. The method of claim 7 further comprising:
determining an identity associated with the mobile device in response to the first request being received, the third request being determined based on the second request and the identity.

10. A method comprising:
receiving information on a location area update regarding a mobile device from an access network; and
disabling a location area update feedback to the location area update regarding the mobile device.

11. The method of claim 10 wherein the information indicates that a one-way update procedure from the mobile device is allowed.

12. The method of claims 10 to 11 further comprising:
initiating a location area deregistration for the mobile device in responding to an expiration of at least one timer; and
resetting the at least one timer in response to receiving the information on the first location area update regarding the mobile device.

13. The method of claim 10 further comprising:
transmitting to the mobile device a message for enabling the first location area update to the mobile device before receiving the information on the first location area update regarding the mobile device.

14. The method of claim 13 wherein the message includes a maximum execution number of the first location area update for the mobile device.

15. The method of claim 10 further comprising:
in response to a current location area of the mobile device being outside of a current location area list of the mobile device, paging the mobile device in at least one location area including the current location area after receiving the information on the first location area update regarding the mobile device.

16. An apparatus comprising:
at least one processor; and
at least one non-transitory memory including computer program code,
the at least one memory and the computer program code being configured to, with the at least one processor, cause the apparatus to:
transmit a first request to establish a radio link, the first request including information on a first location area update;
transmit a second request to execute the first location area update via the radio link; and
release the radio link in response to at least one status of an access stratum feedback to the second request.

17. An apparatus comprising:
at least one processor; and
at least one non-transitory memory including computer program code,
the at least one memory and the computer program code being configured to, with the at least one processor, cause the apparatus to:
receive a first request from a mobile device to establish a radio link, the first request including information on a location area update;
receive a second request to execute the location area update via the radio link from the mobile device;
transmit a third request to a core network, the third request being based on the second request and informing the location area update of the mobile device; and
release the radio link after transmitting an access stratum feedback to the second request via the radio link.

18. An apparatus comprising:
at least one processor; and
at least one non-transitory memory including computer program code,
the at least one memory and the computer program code being configured to, with the at least one processor, cause the apparatus to:
receive information on a location area update regarding a mobile device from an access network; and
disable a location area update feedback to the location area update regarding the mobile device.

19.-33. (canceled)

34. A non-transitory computer readable medium comprising instructions stored thereon for causing an apparatus to perform the method of claim 1.

35. A non-transitory computer readable medium comprising instructions stored thereon for causing an apparatus to perform the method of claim 7.

36. A non-transitory computer readable medium comprising instructions stored thereon for causing an apparatus to perform the method of claim 10.
